(19) United States
(12) Patent Application Publication
(10) Pub. No.: US 2006/0070410 A1
(43) Pub. Date: Apr. 6, 2006

(54) Product anti-theft device

(76) Inventors: Arthur Fuss, Studio City, CA (US); Xiao Hui Yang, Cupertino, CA (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 10/652,518

(22) Filed: Aug. 29, 2003

(51) Int. Cl. E05B 65/00

(52) U.S. Cl. 70/57.1

(57) ABSTRACT

An article anti-theft device has a pair of hinged components that are detachably clamped together about a shaft of an article intended to be protected. The shaft is clamped between the two components with a selected one of the components having a resiliently mounted elongated prong insertably received within the other component and is held thereto by a ball clutch mechanism which includes a tapered housing with an internal tapered wall surface enclosing a plug member having at least two balls carried in opposing seats in the tapered housing and the plug member and a coaxial passageway insertably receives the elongated prong. The plug member is resiliently biased to a first position by an expansion spring causing the balls to bear against the tapered inner wall of the housing, restricting the passageway. When the prong occupies the passageway, the balls are forced outwardly as the plug member moves to compress the spring. The widened mouth of the housing permits the balls to expand and does not place any restriction on the prong. Should the first component with the prong be withdrawn by unauthorized personnel, the plug member will be pushed into the tapered recess of the housing by expansion of the spring and the balls will contract and restrict the prong of the first component, so as to hold the pair of components together. Both components are attached to hinged, mated halves of a clamp member having an open-ended passageway for receiving a shaft of an article to be protected. An electronic transmitter or radiation sensor is carried on the clamp member response to attempted theft in cooperation with a surveillance system.

Priority Based on Ser. No. 60/308,470 filed Aug. 30, 2001 ABANDONED and U.S. Ser. No. 10/208,158 filed Aug. 30, 2002 PENDING

### BACKGROUND OF THE INVENTION

1. Field of the Invention

The present invention relates to the field of anti-theft product devices and, more particularly to a novel device adapted to be releasably secured onto a product intended to be protected from theft, wherein such a device includes a pair of clamp members attached to the product and having a ball clutch mechanism for securing and magnetically releasing the pair of clamp members.

2. Brief Description of the Prior Art

In the field of product loss or theft prevention, various devices such as tags have been provided which are detachably connected to garments, or the like, and that are used to activate an electronic surveillance system including an alarm which would alert attending personnel. Such previous tags usually have one component carrying a transmitter while the other component is employed as a fastening component for joining the two components to a garment. Such practice has been successful in preventing theft of garments; however, a need has existed to protect products other than garments, such as products having cylindrical shafts as golf clubs, necks of beverage bottles or the like. Garment tags rely on insertion of a pin through the garment material so that the shank of the pin is attached to the transmitter component. In dealing with products such as golf clubs, bottles, and the like, penetration of the product or article is not available so that a need has arisen to provide other means for attaching a two-component means for releasable securement onto a solid and non-penetrable product.

Therefore, a long-standing need has existed to provide a two-component product protection device which may readily attach or be clamped to the solid or un-penetrable material that not only contains means for actuating an electronic article surveillance system but one that permits release of the device so that the tag or device may readily be removed from the article at the time of purchase or by authorized personnel.

### SUMMARY OF THE INVENTION

Accordingly, the above problems and difficulties are avoided by the present invention which provides a novel electronic article surveillance device or tag which includes a pair of components that are detachably connected together and which includes means for releasably grasping a portion of a non-penetrable article intended to be protected. The latter means is coupled between the two components and a selected one of the components includes an elongated prong or shaft which is insertably received within the other component and is held thereto by means of a ball clutch mechanism. The mechanism includes a tapered housing with an internal tapered wall surface which encloses a plug member having at least two balls carried in opposing grooves. The tapered housing and the plug member include a coaxial passageway for insertably receiving an elongated prong or pin from the first component. The plug member is resiliently biased to a first position by means of an expansion spring which causes the balls to bear against the tapered inner wall of the housing urging the balls to restrict the passage-way. When the prong or pin of the first component is occupying the passageway, the sides of the pin force the balls outwardly as the plug member moves to compress the spring. The widened mouth of the housing permits the balls to expand and does not place any restriction on the pin. However, should the first component with the pin be withdrawn by unauthorized personnel, the plug member will be pushed into the tapered recess of the housing by expansion of the spring and the balls will contract and restrict the shaft or pin member of the first component, so as to hold the component together.

A clamp means is included in the device as part of the pair of components and the pair of components are hinged together for releasably encircling a shaft or cylindrical member of the product intended to be protected. Release means of a magnetic force field type are provided for effecting release of the ball clutch mechanism with the prong or pin.

Therefore, it is among the primary objects of the present invention to provide a novel hinged together, two-component product protection device against theft or release by unauthorized personnel which includes a ball clutch mechanism permitting a restricted retention of the two components on a non-penetrable article or product and yet permits release thereof by authorized personnel.

Another object of the present invention is to provide a ball clutch mechanism having a clamp for releasably retaining a pair of hinged components together about a non-penetrable article or product intended to be protected against theft.

Still a further object resides in providing a ball clutch mechanism and clamping means for a product theft prevention tag that may be readily fastened to or unfastened from a product which is solid and un-penetrable by a conventional prong or pin.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a front perspective view of the novel product protection tag or device illustrated in connection with attachment to a shaft of a golf club or the like;

FIG. 2 is a longitudinal, cross-sectional view of the ball clutch mechanism and clamping means shown in FIG. 1 as taken in the direction of arrows 2-2 thereof;

FIG. 3 is a transverse, cross-sectional view of the product protection device shown in FIG. 2 illustrated in a locked position, as taken in the direction of arrow 3-3 thereof;

FIG. 4 is a longitudinal, cross-sectional view, similar to the view of FIG. 2, illustrating attachment of the two components when the ball clutch mechanism and clamping means restricts the pin or prong of the first component;

FIG. 5 is a layout plan view of the pair of components; and

FIG. 6 is an exploded perspective view showing the various components and elements of the product anti-theft protection device shown in FIGS. 1 and 2;

### DESCRIPTION OF PREFERRED EMBODIMENT

Referring to FIG. 1, a novel anti-theft tag or device is indicated in the general direction of arrow 10 which comprises a two-component construction wherein numeral 11 identifies one component which is hingeably connected to a second component 12. The first component includes an actuator and release mechanism wherein a manual plunger 13 when depressed, as shown in solid lines, releasably secures the first and second components together by means of a ball clutch mechanism included within the dome 14 carried on the second component. The second component 12 includes a transmitter unit 15 for use in an electronic surveillance system. The second component and the first component include semi-circular surfaces which when joined together when the components are fastened define an open-ended passageway, broadly indicated by numeral 16. Elongated passageway 16 is occupied by a shaft 17, as shown in broken lines, which is representative of a golf club shaft, the neck of a baseball bat or any other shaft-like or cylindrical member intended to be protected against theft. A parting line 18 is illustrated which engages the respective first and second components when they are joined together when the plunger 13 has been depressed. The position of the plunger 13, as illustrated in broken lines, is in preparation for securement of the components together.

When the components are separated, the shaft 17 may be placed in a semi-circular surface area of one of the components, while the other component is pivoted about the shaft and secured thereto so that the shaft occupies the passageway when the plunger 13 is depressed and held together by the ball clutch mechanism within the housing dome 14.

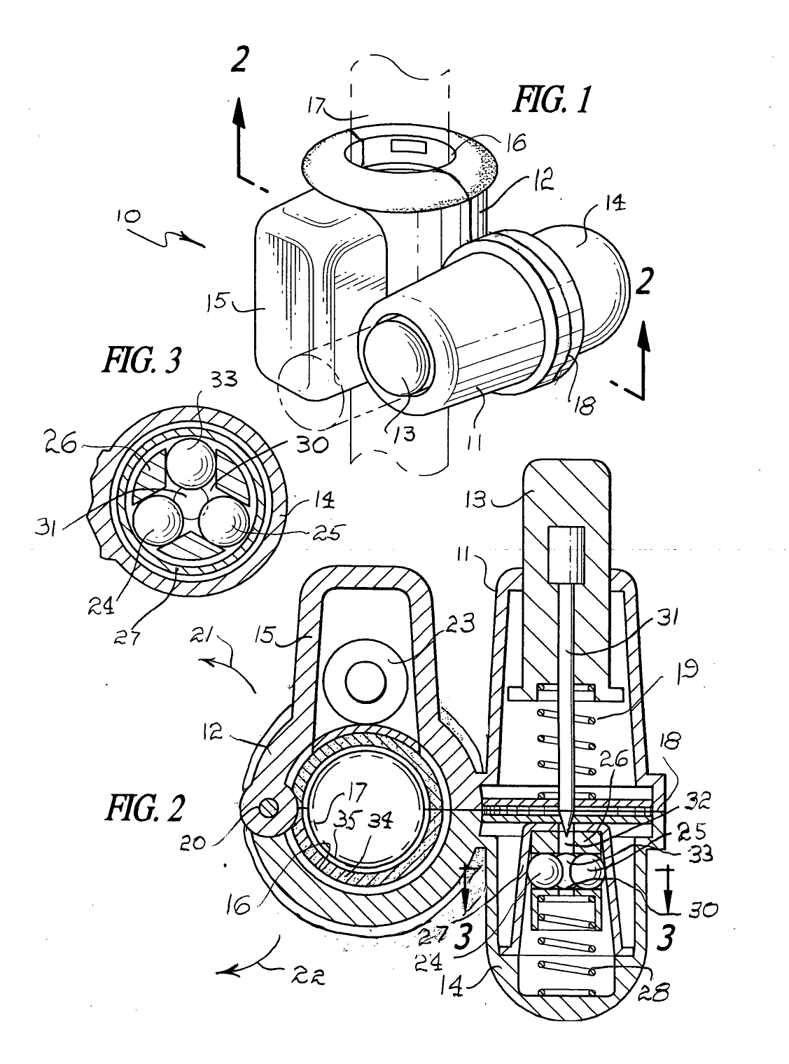

Referring now in detail to FIG. 2, it can be seen that the components 11 and 12 may be separated at the parting line 18 by means of a hinge construction, indicated by numeral 20. One portion of the hinge is carried on the member 12, while the other portion of the hinge is carried on member 11. The respective movements of the components are illustrated by the arrows number 21 and 22 when the components are rotated about the hinge mechanism 20. It is to be noted that the transmitter housing 15 encloses a conventional transmitter 23 as is used in a conventional surveillance and anti-theft control system.

As can be seen in FIG. 2, the product 17 to be protected is captured between the components 11 and 12 and that the clutch housing 14 incorporates a ball-bearing clutch assembly which includes at least two balls 24 and 25 that are captured within recesses provided in a plug member 26. The plug member is adapted to move in a rectilinear manner within a tapered housing 27. The housing 27 includes a tapered internal recess which has a wide opening at the bottom thereof. Therefore, the plug member may move sufficiently within the tapered recess to permit the balls to bear against the tapered wall of the housing within their respective openings. A spring 28 may be an expansion helical spring normally urging the plug member 26 upwardly against the top of the housing 27. Therefore, in this position, the balls 24 and 25 are forced into an elongated passageway forming a restriction and reduction in the diameter of the passageway 30. However, when a pin 31 is inserted into the passageway 30 via an introduction passageway 32 formed in the clutch housing 20, housing 27 and plug member 26, the balls 24 and 25 are engaged and as the pin moves downwardly, the movement carries the plug member against the expansion of the spring 27. This condition occurs until the backside of the balls 24 and 25 substantially reach the wider opening to the housing recess, at which time downward pin movement ceases. The balls then close about the pin so that the spring urges the plug member upward to release the pin and permit the pin to be retracted through passageway 30. A magnetic force is applied to the housing 14 which pulls the balls into the wide opening against the spring force so that the balls separate to release their hold on the pin.

The two components are opened by maintaining the balls 23 and 24 at the wider opening of the housing 27 so that the pin is not restricted and can be moved upwardly out of the clutch housing 20.

It can also be seen in FIG. 2 that a third ball 33 can be included in combination with balls 24 and 25 to restrain the pin 31 when the plunger 13 is depressed. Also, it can be seen that both components 11 and 12 are hinged together by the hinge mechanism 20 and that the shaft 17 is within the open-ended passageway 16. A cushion liner 34 is included in the passageway 16 in order to prevent chaffing or damage of the shaft 17 by the semi-circular surfaces of the two components. The cushion liner 16 includes a plurality of ribs, such as rib 35, which projects into the passageway so as to engage with the outer surface of the shaft 17.

Referring now in detail to FIG. 3, the pin 31 is illustrated preparatory for occupying the passageway 30 and is illustrated in its pre-retention condition with the balls 24, 25 and 33 ready to expand outwardly to engage with the inner wall surface of the housing 27. It can be seen that the three balls are retained within their cavities in the plug member 26 but are permitted to expand outwardly as the pin 31 progresses into engagement with the balls.

Referring now to FIG. 4, the pin 31 is illustrated in the restricted position, whereby the balls bear against the external surface of the pin so that the two components are held together. The plug member 26 has been moved through the tapered recess to compress the helical spring 28. The backside of each of the respective balls bears against the inside tapered surface of the housing 27 so that the pin will remain restricted until released, which is achieved by application of magnetic force via magnet 53.

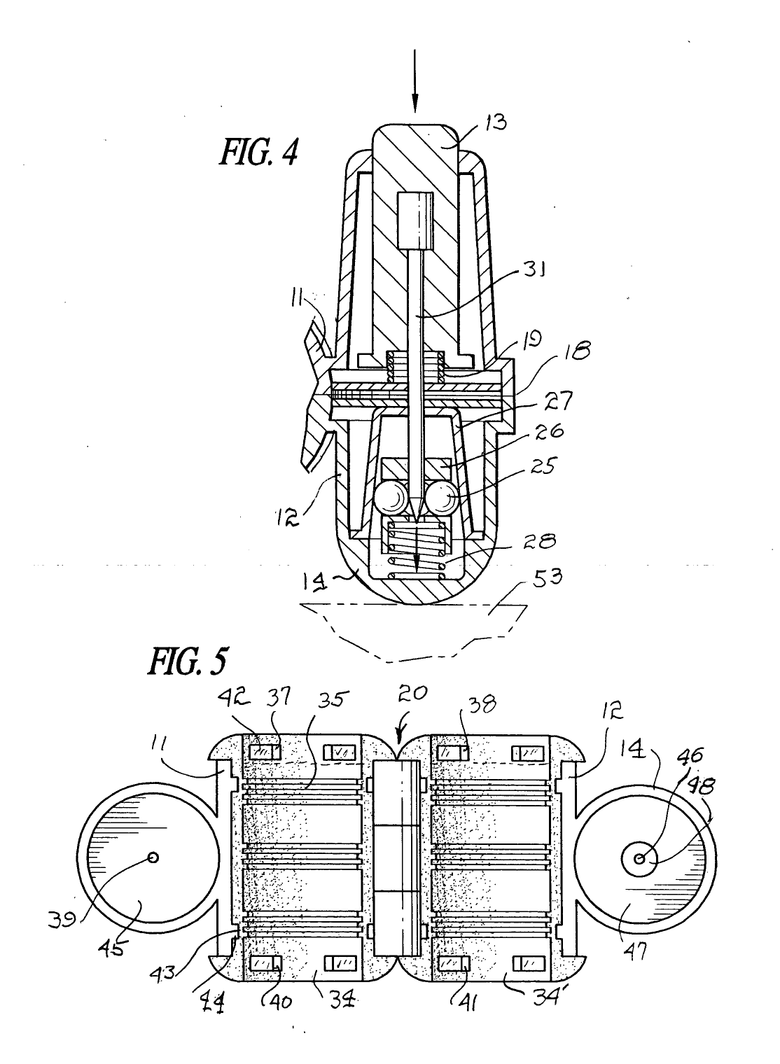

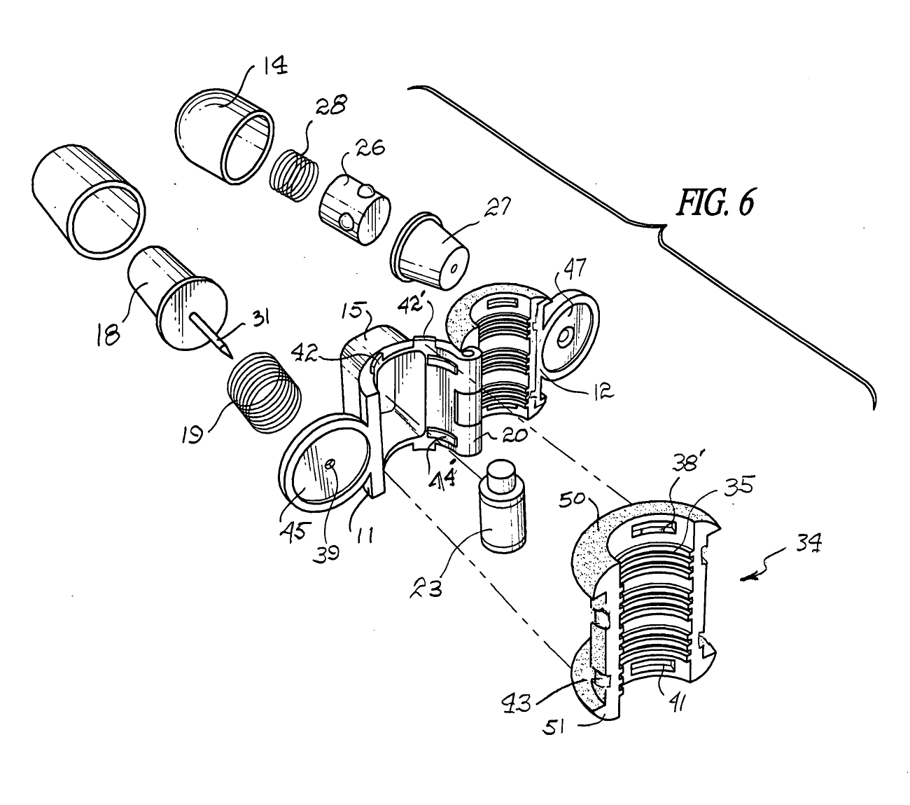

In FIG. 5, the two components 11 and 12 are illustrated as being separated about the hinge mechanism 20. The liner 34 and 34′ are illustrated in connection with the pair of components and the ribs 35 on the liners are clearly illustrated. The liners include upper and lower openings represented by numerals 37 and 38 and numerals 40 and 41 respectively. A tab, such as tab 42, is carried on the respective components 11 and 12 so as to mate and match with the openings 37, 38 and openings 40 and 41 for mounting of the liners to the respective components. Also, the exterior surface of the liners include grooves, such as grove 43, for receiving an alignment rib 44 carried on each of the components. Therefore, once the tabs 42 have been inserted through the respective openings, such as opening 37, and the ribs 44 have been placed into the alignment grooves 43, the liners fit snugly against their respective component, preparatory for closing about the shaft 17.

It can also be seen that the component 11 includes a plate 45 having a hole 39 through which the pin 31 can project when the plunger 13 has been depressed. The end of the pin will be in alignment with an opening 46 in a plate 47 carried on the ball mechanism housing 14. A tapered recess 48 serves as a guide for aligning the end of the pin with the opening 46 to operate the ball clutch mechanism.

Referring now in detail to FIG. 6, an exploded view is illustrated of the components 11 and 12 which are joined together by the hinge mechanism 20. It can be seen that the cushion liner 34 is placed into respective semi-circular cavities in the members 11 and 12 after initially placing the transmitter 23 into housing 14, followed by aligning the tabs, such as tab 42′, with the openings, such as opening 38′, in the liner. Both top and bottom tabs and openings are matched as well as the ribs, such as rib 44′, with external groove 43. When everything is in alignment, the resilient and soft cushion liner 34 is pressed into position. The top and bottom of each liner incorporates a soft shoulder wherein numeral 50 indicates a top shoulder of liner 34, while numeral 51 indicates the lower or bottom shoulder. These shoulders are exposed beyond the periphery of the components and the liner carried on component 12 illustrates the extension of the shoulders beyond the periphery. If needed, the transmitter 23 may be retained within the cavity of housing 15 by a spacer or wedge element (not shown).

It can also be seen that spring 19 for the plunger 18 is between the plate 45 and the plunger with the pin 31 adapted to pass through the opening 39. In a similar fashion, the expansion spring 28 is disposed between the bottom of housing 14 and the plug member 26 so as to normally urge the plug 26 into the tapered recess of housing 27.

In view of the foregoing, it can be seen that the anti-theft prevention device of the present invention provides a suitable means that is readily attached to a cylindrical or circular product, such as the shaft of a golf club or the like. A suitable transmitter may be located in the housing, and it is noted that the specific transmitter is not a part of the present invention. The respective first and second component are maintained in securement or maintained release by means of the ball clutch mechanism which can be operated by insertion of pin 31 into the mechanism. For release of the pin from the clutch mechanism, reference is made to FIG. 4 wherein a magnet 53 is employed for creating a magnetic force which pulls the balls downward against the tension of the spring 28. The plug member 26 is pulled downward in unison so that the balls are permitted to expand as they approach the opening in the bottom of housing 27. As the balls expand, the pin 31 is released and the compressed spring 19 is free to expand, causing the plunger and pin to raise, removing the pin from the clutch mechanism and effecting disconnect between the two components.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

1-14. (canceled)

15. An anti-theft tag comprising:
a first component having shaped surfaces;
a second component hingably associated with said first component, said second component having shaped surfaces;
said shaped surfaces on said first component and said second component together defining an open-ended passageway having a desired cross section when said first component and said second component are rotated against each other;
a spring-biased pin with a shaft, carried upon said first component;
means on said second component for releasably maintaining said first component and said second component against each other by acting on said shaft of said spring-biased pin, and;
an electronics housing associated with either said first component or said second component, said electronics housing containing an electronic device for being detected in an anti-theft system; wherein,
said open-ended passageway fits around a portion of an object to be protected from theft, and is the sole manor of maintaining said anti-theft tag on said object.

16. The anti-theft tag of claim 15, wherein:
the direction of said pin is in fixed angular orientation with respect to said first component.

17. The anti-theft tag of claim 16, wherein:
said direction of said pin does not intersect said open-ended passageway when said first component and said second component are rotated against each other.

18. The anti-theft tag of claim 16, wherein:
a directional line directed along said direction of said pin intersects said open-ended passageway when said first component and said second component are rotated against each other.

19. The anti-theft tag of claim 15, wherein:
said desired cross section of said open-ended passageway is round.

20. The anti-theft tag of claim 15, wherein:
the removal of said pin from said means for releasably retaining said pin is facilitated with a magnetic detacher.

21. (canceled)

22. The anti-theft tag of claim 15, wherein:
means for releasably retaining said pin is a ball clutch.

23. The anti-theft tag of claim 22, wherein:
said ball clutch uses two balls.

24. The anti-theft tag of claim 22, wherein:
said ball clutch uses three or more balls.

25. An anti-theft tag comprising:
a first component having shaped surfaces;
a spring-biased pin with a shaft, carried upon said first component;
a second component hingably associated with said first component, said second component having shaped surfaces;
an aperture for releasably retaining said shaft of said pin, said aperture carried upon said second component;
an electronics housing associated with either said first component or said second component, said electronics housing containing an electronic device for being detected in an anti-theft system; wherein,
when said first component and said second component are rotated against each other so that said shaped surfaces are mated together, said shaped surfaces together define an open-ended passageway having a desired cross section and said shaft of said pin may be inserted into said aperture for releasably retaining said shaft of said pin, thus releasably holding said first and said second components against each other and;
said open-ended passageway fits around a portion of an object to be protected from theft, and is the sole manor of maintaining said anti-theft tag on said object.

26. The anti-theft tag of claim 25, wherein:
a ball clutch is associated with said aperture for releasably retaining said shaft of said pin.

27. The anti-theft tag of claim 26, wherein:
said ball clutch uses two or more balls.

28. (canceled)
